(19) United States
(12) Patent Application Publication
(10) Pub. No.: US 2004/0125220 A1
(43) Pub. Date: Jul. 1, 2004

(54) Image capturing apparatus, method of adjusting luminance of the same, and program product

(75) Inventors: Akira Fukuda, Osaka (JP); Toshio Nagai, Yokohama-Shi (JP); Tsutomu Honda, Osaka (JP)

Correspondence Address: McDERMOTT, WILL & EMERY, 600 13th Street, N.W., Washington, DC, 20005, US

(73) Assignee: MINOLTA CO., LTD.

(21) Appl. No.: 10/421,791

(22) Filed: Apr. 24, 2003

(30) Foreign Application Priority Data
Dec. 25, 2002 (JP) P2002-374706

(51) Int. Cl. H04N 5/232; H04N 9/68

(52) U.S. Cl. 348/234; 348/345

(57) ABSTRACT

A digital camera has a display such as an LCD. A viewfinder image obtained by a CCD before photographing is displayed on the display, and a pointer which can be moved up, down, right and left by operation of the user is displayed so as to be superimposed on the viewfinder image. A histogram indicative of a luminance distribution of the whole viewfinder image and a marker indicative of luminance of a pixel of a portion designated by the pointer are displayed so as to be superimposed on the viewfinder image. By displaying the marker, the user can grasp luminance information of a part of the viewfinder image.

This application is based on application No. 2002-374706 filed in Japan, the contents of which are hereby incorporated by reference.

### BACKGROUND OF THE INVENTION

2. Field of the Invention

The present invention relates to an image capturing apparatus capable of obtaining a preview image of a subject before photographing.

2. Description of the Background Art

Some digital cameras (image capturing apparatuses) can display not only a captured image on a display such as an LCD but also various information before photographing.

For example, the following Patent Literature 1 discloses a technique of displaying a luminance distribution of a viewfinder image as a histogram in a real-time manner on a display together with the viewfinder image (preview image) before photographing. By the technique, the user can grasp the luminance distribution of a whole viewfinder image.

### Patent Literature 1

### Japanese Patent Application Laid-Open No. 2002-84441

However, since only the luminance distribution of a whole viewfinder image is displayed in Patent Literature 1, luminance information of a part of a viewfinder image desired by the user, for example, in a narrow area on a main subject which is a human being or the like cannot be grasped.

### SUMMARY OF THE INVENTION

The present invention is directed to an image capturing apparatus.

According to the present invention, an image capturing apparatus comprises: (a) an image capturing part for obtaining a preview image of a subject before photographing; (b) a display for displaying the preview image; (c) a designating member for designating a luminance detection portion in the preview image displayed on the display; and (d) a display controller for displaying luminance information of image data of the luminance detection portion on the display. Therefore, luminance information of a part of a viewfinder image can be grasped.

According to a preferred embodiment of the present invention, the image capturing apparatus further comprises (e) a focus controller for performing a focus control on the basis of image data in a focus area in the preview image, and the luminance detection portion and the focus area move interlockingly with each other in the preview image. Consequently, operability of the image capturing apparatus is improved.

The present invention is also directed to a luminance adjusting method of an image capturing apparatus before photographing, and a program product.

An object of the present invention is therefore to provide a technique of an image capturing apparatus capable of grasping luminance information of a part of a viewfinder image.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1 to 3 illustrate schematic configurations of the appearance of a digital camera according to a preferred embodiment of the present invention;

FIG. 4 is a schematic block diagram showing the internal configuration of the digital camera;

FIG. 5 is a diagram for describing data recorded on a memory card;

FIG. 6 is a flowchart for describing a basic operation of the digital camera;

FIGS. 7 to 10 are image views for describing the operation of the digital camera; and

FIGS. 11 and 12 are image views for describing the operation of the digital camera according to a modification of the present invention.

### DESCRIPTION OF THE PREFERRED EMBODIMENTS

### Configuration of Main Components of Digital Camera

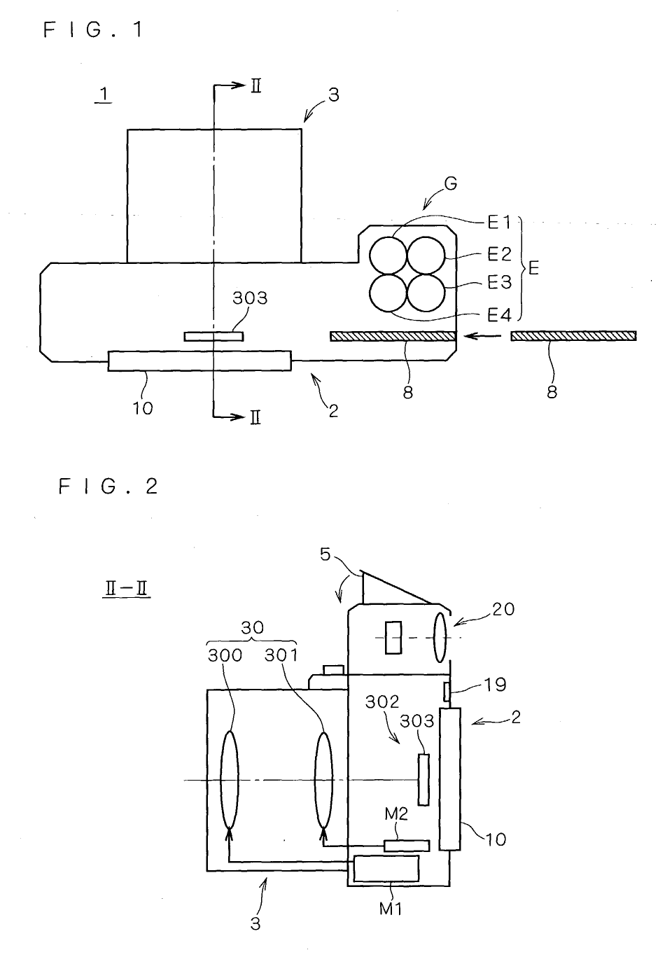

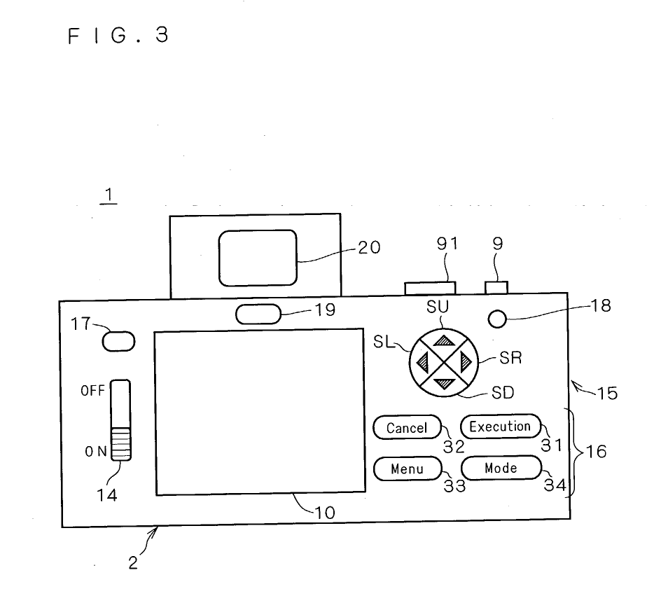

FIGS. 1 to 3 illustrate schematic configurations of the appearance of a digital camera 1 according to a preferred embodiment of the present invention. FIG. 1 is a plan view of the digital camera 1, FIG. 2 is a cross-sectional view taking along line II-II of FIG. 1, and FIG. 3 is a rear view of the digital camera 1.

The digital camera 1 functions as an image capturing apparatus and comprises a camera body 2 having an almost rectangular parallelepiped shape, and a taking lens 3 detachably attached to the camera body 2. As shown in FIG. 1, a memory card 8 for recording a captured image is removably inserted into the digital camera 1. The digital camera 1 has, as a driving source, a power source battery E in which four AA cells E1 to E4 are connected in series.

As shown in FIG. 2, the taking lens 3 as a zoom lens has a lens unit 30. As the taking lens 3, a two-group zoom lens is shown herein. The lens unit 30 is broadly divided into two lens units 300 and 301. In FIGS. 2 and 3, for convenience of the figures, each of the lens units 300 and 301 is shown as a single lens. In practice, however, each of the lens units 300 and 301 is not limited to a single lens but may be an assembly of a plurality of lenses.

The camera body 2 has therein a motor M1 for driving the lens unit 300, and a motor M2 for driving the lens unit 301. By the driving of the motors M1 and M2, the lens units 300 and 301 move in the optical axis direction independently of each other, so that the zoom magnification of the taking lens 3 can be changed. By driving the lens units 300 and 301 with the motors M1 and M2, the in-focus state of the taking lens 3 can be changed, that is, a focusing operation can be performed.

In a proper position on the rear side of the lens unit 30 of the taking lens 3, a color image capturing device 303 is provided. The color image capturing device 303 includes a single-chip color area sensor in which color filters of R (red), G (green) and B (blue) are adhered in a checkered pattern on the surface of pixels of an area sensor formed of a CCD. The color image capturing device (hereinafter, referred to as a “CCD (Charge Coupled Device)”) has, for example, 2500×1920 pixels. The CCD 303 functions as an image capturing part for capturing a viewfinder image (preview image) of the subject before photographing.

In the front face of the camera body 2, a grip G is provided as shown in FIG. 1. In a proper position at an upper end of the camera body 2, a built-in electronic flash 5 of a pop-up type is provided. The built-in electronic flash 5 can emit flat light.

As shown in FIG. 3, on the top face of the camera body 2, a shutter start button 9 and a dial 91 are provided. The shutter start button 9 has the function of detecting and determining a touched state (referred to as “S1 state”) used as a trigger of focus adjustment or the like and a depressed state (referred to as “S2 state”) used as a trigger of image capturing for recording.

By turning the dial 91, various set values can be easily continuously changed. In the case of shifting to a point selection mode (which will be described later), the dial 91 is switched to serve as a member for correcting exposure. Specifically, when a point selection function (point selection mode) is enabled, on the basis of an operation input to the dial 91 as a specific operation member, an exposure setting for exposure correction is made. When the point selection function is disabled, on the basis of an operation input to the dial 91, a setting of any of the other kinds different from the exposure setting is made. Consequently, the exposure correction can be easily promptly performed. The settings of the other kinds include, for example, adjustments of contrast and saturation and are mainly settings of image capturing conditions other than the exposure adjustment.

In the rear face of the camera body 2, an electronic viewfinder (hereinafter, referred to as “EVF”) 20 and a liquid crystal display (hereinafter, referred to as “LCD”) 10 are provided. The EVF 20 and the LCD 10, different from an optical viewfinder, for displaying a live view based on image signals from the CCD 303 in an image capturing standby state function as a viewfinder, and can perform display based on a viewfinder image before photographing.

The LCD 10 can display a menu screen for setting a image capturing mode, image capturing conditions and the like in a recording mode, and can reproduce and display a captured image which is recorded on the memory card 8 in a reproduction mode.

In a left part of the rear face of the camera body 2, a power supply switch 14 is provided. In a right part of the rear face, a crossed switch 15 is provided. The crossed switch 15 has operation buttons. By depressing buttons SU, SD, SL and SR in the four directions of up, down, left and right in the operation buttons, various operations can be performed. For example, the crossed switch 15 functions as a switch for changing an item selected on the menu screen displayed on the LCD 10 and changing a frame to be reproduced which is selected in an index screen. In the recording mode, the buttons SL and SR in the left and right directions function as a switch for changing the zoom magnification. Concretely, the positional relationship between the two lens units 300 and 301 is changed by the driving of the motors M1 and M2, thereby changing the zoom magnification. More specifically, when the right-direction switch SR is depressed, the lens units 300 and 301 are continuously moved to the wide angle side. When the left-direction switch SL is depressed, the lens units 300 and 301 are continuously moved to the telephoto side.

Below the crossed switch 15, a switch group 16 of an execution switch 31, a cancel switch 32, a menu display switch 33, a mode selection switch 34 and the like is provided. The execution switch 31 is a switch for determining or executing an option selected in the menu screen. The cancel switch 32 is a switch for canceling an option selected in the menu screen. The menu display switch 33 is a switch for displaying the menu screen on the LCD 10 or switching an option in the menu screen. The mode selection switch 34 is a switch for switching the mode between the “image capturing mode” and the “reproduction mode.” image capturing mode is a mode of capturing a still image or a moving image. The reproduction mode is a mode of reproducing and displaying a captured image recorded on the memory card 8 onto the LCD 10 or EVF 20. When the digital camera 1 is started, the image capturing mode is automatically selected. Each time the mode selection switch 34 is depressed after the start, the image capturing mode and the reproduction mode are switched.

On the rear face of the camera body 2, a display switch button 17 is provided above the power supply switch 14, and an AE lock button 18 is provided in the vicinity of the shutter start button 9. The display switch button 17 is a button for switching the mode to a luminance information display mode of displaying a histogram indicative of a luminance distribution of image data so as to be superimposed on a live view image displayed on the LCD 10 (EVF 20). The AE lock button 18 is a button for locking an AE setting. When the point selection mode which will be described later is selected, by depressing the AE lock button 18, pre-emission of the built-in electronic flash 5 is brought about.

On the rear face of the camera body 2, an eye approach sensor 19 is provided in a central upper part of the LCD 10. The eye approach sensor 19 senses approach of the user to the EVF 20 when the user sees the object through the EVF 20. When the approach of the user is detected, the EVF 20 is turned on.

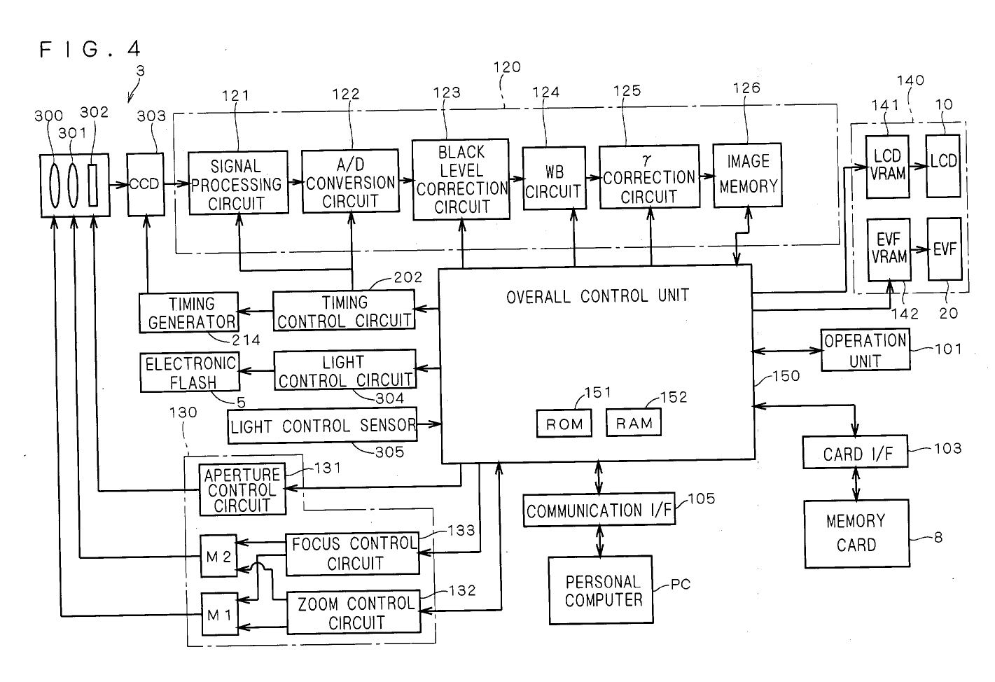

The internal configuration of the digital camera 1 will now be described. FIG. 4 is a schematic block diagram showing the internal configuration of the digital camera 1.

The taking lens 3 has therein, in addition to the lens units 300 and 301, an aperture 302 for adjusting a transmission light amount. Although it is shown in FIG. 4 that, for convenience, the aperture 302 is disposed on the rear side of the lens unit 301, the position of the aperture 302 is not limited thereto. For example, the aperture 302 may be provided in the lens unit 301 (or 300) or between the lens units 300 and 301.

The CCD 303 photoelectrically converts a light image of a subject formed by the taking lens 3 into image signals of color components of R (red), G (green) and B (blue) (signal formed of a signal sequence of pixel signals received by pixels) and outputs the image signals. A timing generator 214 generates various timing pulses for controlling the driving of the CCD 303.

An exposure control in the digital camera 1 is performed by adjusting the aperture 302 and an exposure amount of the CCD 303, that is, charge accumulation time corresponding to shutter speed. In the case where a proper shutter speed cannot be set when the luminance of the subject is low, by adjusting the level of an image signal outputted from the CCD 303, improper exposure due to insufficient exposure is corrected. That is, when the luminance is low, the exposure control is performed by combining the shutter speed and gain adjustment. The level of an image signal is adjusted by adjusting the gain of an AGC circuit in a signal processing circuit 121.

The timing generator 214 generates a drive control signal of the CCD 303 on the basis of a reference clock sent from a timing control circuit 202. The timing generator 214 generates, for example, clock signals such as timing signals of start/end of integration (start/end of exposure) and read control signals (horizontal sync signal, vertical sync signal, transfer signal and the like) of photo-reception signals of pixels, and outputs the signals to the CCD 303.

A signal processor 120 performs a predetermined analog signal process and digital signal process on an image signal outputted from the CCD 303. The signal processes on the image signal are performed on each of photo-reception signals of pixels constructing image data. The signal processor 120 has the analog signal processing circuit 121, an A/D conversion circuit 122, a black level correction circuit 123, a white balance (WB) circuit 124, a γ correction circuit 125 and an image memory 126.

The analog signal processing circuit 121 performs the analog signal process and mainly includes a CDS (Correlated Double Sampling) circuit and an AGC (Auto Gain Control) circuit. The analog signal processing circuit 121 reduces sampling noise in a pixel signal outputted from the CCD 303 and adjusts the signal level. The gain control in the AGC circuit is performed also for compensating insufficient level of a captured image in the case where proper exposure cannot be obtained by the f-number of the aperture 302 and the exposure time of the CCD 303.

The A/D conversion circuit 122 converts an image signal as an analog signal outputted from the analog signal processing circuit 121 to image data as a digital signal. The image data obtained by the conversion is temporarily stored in the image memory 126.

The black level correction circuit 123 corrects the black level of the image signal which is A/D converted by the A/D conversion circuit 122 to a reference black level. The WB circuit 124 shifts the level of image data of each of the color components of R, G and B. The WB circuit 124 shifts the level of the image data of each of the color components of R, G and B by using a level conversion table inputted from an overall control unit 150. The conversion coefficient (gradient of the characteristic) of each of the color components of the level conversion table is set for each captured image by the overall control unit 150.

The γ correction circuit 125 is a circuit for correcting the γ characteristic of image data and corrects the level of image data by using a preset γ correction table.

The image memory 126 is a memory for temporarily storing image data outputted from the γ correction circuit 125. The image memory 126 has a storage capacity capable of storing image data of one frame. That is, the image memory 126 has a capacity of storing image data of 2500×1920 pixels corresponding to the number of pixels of the CCD 303 and each pixel data is stored in a corresponding pixel position.

A light control circuit 304 controls a light emission amount of the built-in electronic flash 5 in photographing with electronic flash light to a predetermined light emission amount which is set by the overall control unit 150. In the photographing with electronic flash light, reflection light of electronic flash light from the subject is received by a light control sensor 305 simultaneously with start of exposure. When the light reception amount reaches a predetermined light emission, a light emission stop signal is outputted from the light control circuit 304. In response to the light emission stop signal, light emission of the built-in electronic flash 5 is forcedly stopped, thereby controlling the light emission amount of the built-in electronic flash 5 to a predetermined light emission amount.

A lens control unit 130 controls the driving of each of the lens units 300 and 301 and the aperture 302 in the taking lens 3. The lens control unit 130 has: an aperture control circuit 131 for controlling the f-number of the aperture 302; a zoom control circuit 132 for changing a variable power of the zoom (in other words, changing the field angle) by driving the motors M1 and M2; and a focus control circuit 133 for performing a focusing control by driving the motors M1 and M2.

The aperture control circuit 131 drives the aperture 302 on the basis of the f-number inputted from the overall control unit 150 and sets the aperture amount as the f-number. The focus control circuit 133 controls the driving amount of the motors M1 and M2 on the basis of an AF control signal inputted from the overall control unit 150 and sets the lens units 300 and 301 to the focus position. The zoom control circuit 132 moves the lens units 300 and 301 by driving the motors M1 and M2 on the basis of a zoom control signal inputted from the overall control unit 150 in accordance with an input by the crossed switch 15. By the operation, the state of the zoom changes to the wide angle side or telephoto side.

A display unit 140 displays an image on the LCD 10 and EVF 20. The display unit 140 has, together with the LCD 10 and the EVF 20, an LCD VRAM 141 as a buffer memory of image data reproduced and displayed on the LCD 10, and an EVF VRAM 142 as a buffer memory of image data reproduced and displayed on the EVF 20. The LCD VRAM 141 has a storage capacity of image data corresponding to the number of pixels 640×480 of the LCD. The EVF VRAM 142 has a storage capacity of image data corresponding to the number of pixels of 400×300 of the EVF 20.

In the image capturing standby state, each pixel data in an image (viewfinder image) sequentially generated every 1/30 second by the CCD 303 is subjected to a predetermined signal process by the signal processor 120 and the processed data is temporarily stored in the image memory 126. The stored data is read by the overall control unit 150 and the data size is adjusted. After that, the data is transferred to the LCD VRAM 141 and the EVF VRAM 142 and displayed as a viewfinder image on the LCD 10 and the EVF 20. Consequently, the user can visually recognize the subject image. In the reproduction mode, an image read from the memory card 8 is subjected to a predetermined signal process by the overall control unit 150, and the processed image is transferred to the LCD VRAM 141 and reproduced and displayed on the LCD 10.

An operation unit 101 inputs operation information of the operation members regarding photographing and reproduction, which is provided for the camera body 2 to the overall control unit 150. The operation information inputted from the operation unit 101 includes operation information of the operation members such as the shutter start button 9, power supply switch 14, crossed switch 15 and switch group 16.

The overall control unit 150 takes the form of a microcomputer and controls the photographing function and reproduction function in a centralized manner. To the overall control unit 150, the memory card 8 is connected via a card interface 103. A personal computer PC is also externally connected via a communication interface 105

The overall control unit 150 has: a ROM 151 in which a process program for performing various concrete processes in the photographing function and the reproduction function and a control program for controlling the driving of each of components of the digital camera 1 are stored; and a RAM 152 as a work area for performing various computing works in accordance with the process program and the control program. Program data such as a luminance display program recorded on the memory card 8 as a recording medium can be read via the card I/F 103 and stored into the ROM 151. Therefore, the process program and control program can be installed from the memory card 8 into the digital camera 1. The process program and control program can be installed from the personal computer PC via the communication I/F 105.

The overall control unit 150 has a luminance determining unit and an exposure amount setting unit for setting exposure control values (shutter speed (SS) and f-number).

Further, the overall control unit 150 has: a filter unit for performing a filtering process; and a recording image generating unit for generating a thumbnail image and a compressed image, in order to perform a process of recording the captured image. The overall control unit 150 has a reproduction image generating unit for generating a reproduction image in order to reproduce the image recorded on the memory card 8 onto the LCD 10 and EVF 20.

The filter unit corrects high-frequency components of an image to be recorded by a digital filter, thereby correcting the picture quality of a contour. The recording image generating unit reads image data from the image memory 126 and generates a thumbnail image and a compressed image to be recorded on the memory card 8. The recording image generating unit reads pixel data every eight pixels in each of the lateral and vertical directions from the image memory 126 and sequentially transfers the read pixel data to the memory card 8. In such a manner, while generating a thumbnail image, the thumbnail image is recorded on the memory card 8. Further, the recording image generating unit reads all of pixel data from the image memory 126, performs a predetermined compressing process according to the JPEG method such as two-dimensional DCT or Huffman coding on the pixel data to generate compressed image data, and records the compressed image data into an image area in the memory card 8.

When photographing is instructed by the shutter start button 9 in the image capturing mode, after the image capturing instruction, the overall control unit 150 generates a thumbnail image of the image stored in the image memory 126 and a compressed image which is compressed according to the JPEG method at a set compression ratio. The overall control unit 150 stores the images into the memory card 8 together with information such as tag information regarding a captured image (frame number, exposure value, shutter speed, compression ratio, date of photographing, data of on/off of electronic flash at the time of photographing, scene information, a result of determination of an image, and the like).

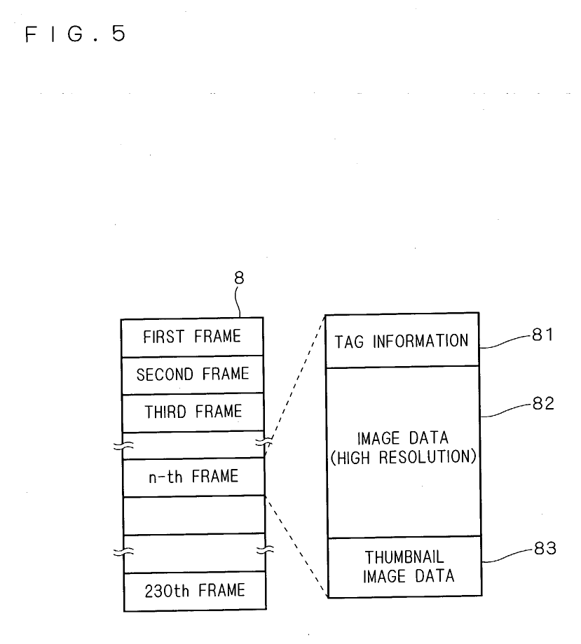

In each frame of an image recorded on the memory card 8 via the card I/F 103, as shown in FIG. 5, tag information 81, image data 82 (600×1200 pixels) of high resolution compressed in a JPEG format, and image data 83 (80×60 pixels) for displaying a thumbnail are recorded.

When a reproduction mode is selected by the mode selection switch 34, image data of the largest frame number in the memory card 8 is read and decompressed in the reproduction image generating unit. The decompressed image is transferred to the LCD VRAM 141 and the EVF VRAM 142, thereby displaying the image of the largest frame number, that is the image obtained most recently on the LCD 10 and EVF 20. By operating the button SU, the image of the large frame number is displayed. By depressing the button SD, an image of the small frame number is displayed.

### Operation of Digital Camera 1

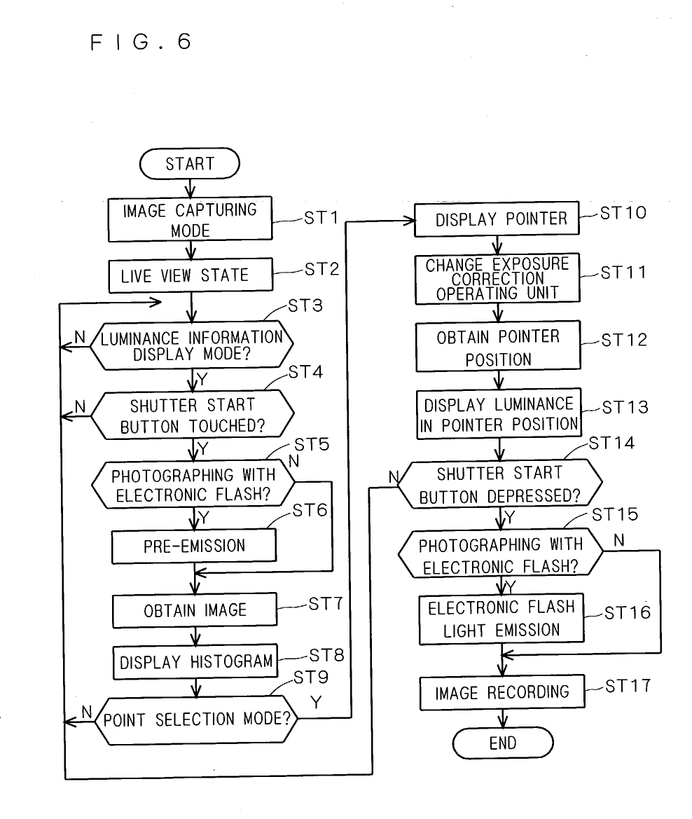

FIG. 6 is a flowchart for describing a basic operation of the digital camera 1. The operation is performed when a luminance information display program stored in the ROM 151 of the overall control unit 150 is executed.

First, the user turns on the power supply switch 14 to select the image capturing mode by the mode selection switch 34 (step ST1).

In step ST2, on the basis of image data obtained by the CCD 303, a viewfinder image G1 shown in FIG. 7 is displayed as a live view on the LCD 10. When the eye approach sensor 19 detects approach of the user's eye, the LCD 10 is turned off, the EVF 20 is turned on, and the viewfinder image G1 is displayed on the EVF 20. In the following, for convenience of description, the case where approach of the user's eye is not detected, that is, the case where a viewfinder image is displayed on the LCD 10 will be described. In the case where an optical viewfinder is provided on the digital camera 1, when the user uses the optical viewfinder, the LCD 10 and EVF 20 are turned off.

In step ST3, whether the luminance information display mode is selected or not is determined. Herein, whether the luminance information display mode is selected or not is determined by the operation of the user on the display switch button 17. When the luminance information display mode is selected, the program advances to step ST4. When the luminance information display mode is not selected, the program returns to step ST3.

In step ST4, whether the shutter start button 9 is touched by the user or not is determined. If YES, the program advances to step ST5. If NO, the program returns to step ST3.

In step ST5; whether the electronic flash photographing mode is selected or not is determined. For example, when the built-in electronic flash 5 is popped up, it is determined that the electronic flash photographing mode is set. When the electronic flash photographing mode is selected, the program advances to step ST6. When the electronic flash photographing mode is not selected, the program advances to step ST7.

In step ST6, the built-in electronic flash 5 preliminarily emits light before photographing. As the light emission method of the built-in electronic flash 5, flat light emission is preferable in this case. The pre-emission is not essential when the user touches the shutter start button 9 (step ST4) but may be carried out when the user depresses the AE lock button 18.

In step ST7, image data is obtained by the CCD 303. At this time, it is not essential to obtain image data of which total pixel number is 2500×1920 of the CCD 303, but image data obtained by skipping the pixels to the number of display pixels of the LCD 10 may be obtained. Consequently, luminance information which will be described later can be promptly obtained.

When pre-emission is carried out in step ST6, image data of a viewfinder image obtained with the pre-emission of the built-in electronic flash 5 may be recorded on the memory card 8. Since the image captured with the pre-emission can be recorded, an opportunity of taking a good picture can be prevented from being missed.

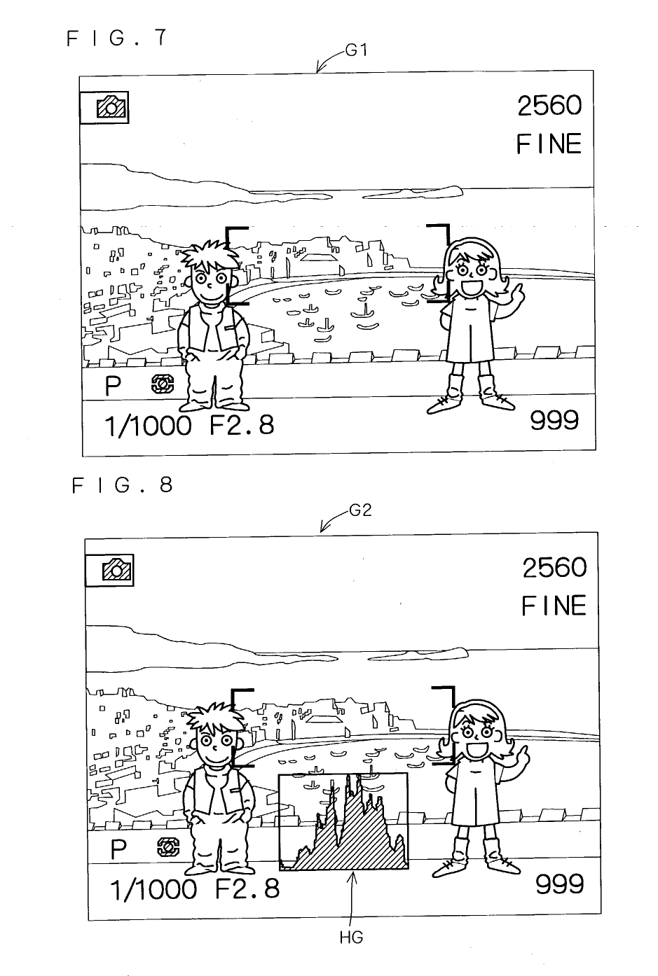

In step ST8, a histogram is displayed on the LCD 10. Concretely, as shown in FIG. 8, a histogram HG (hatched portion) indicative of the luminance distribution of a whole image obtained by the CCD 303 is displayed so as to be superimposed on a viewfinder image G2. Also in the case where an optical viewfinder is provided on the digital camera 1 and the user uses the optical viewfinder, a histogram is displayed on the LCD 10.

In step ST9, whether the point selection mode has been selected or not is determined. When depression of the display switch button 17 by the user for, for example, a few seconds is detected, it is determined that the point selection mode is designated. When the point selection mode is selected, the program advances to step ST10. When the point selection mode is not selected, the program returns to step ST3.

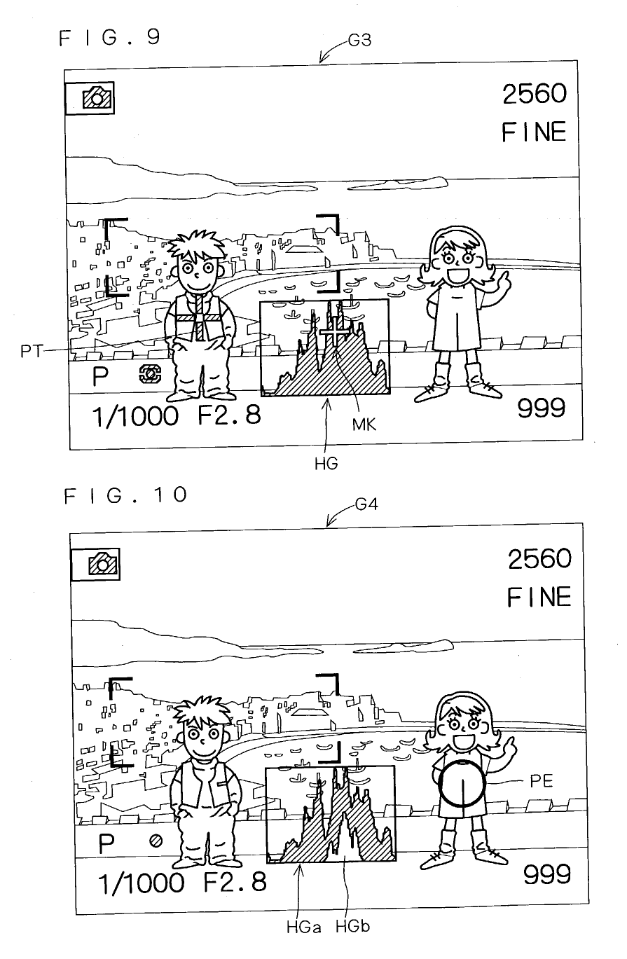

In step ST10, a pointer is displayed. Concretely, as shown in FIG. 9, a cross-shaped pointer PT for designating a luminance detection portion corresponding to a part of a viewfinder image G3 is displayed so as to be superimposed on the viewfinder image G3. In this case, the user operates the crossed switch 15 to move the pointer PT up, down, right and left in the screen of the LCD 10, thereby enabling a designation position in the screen to be set by the user.

In a menu screen switched by the menu display switch 33, a focus point may be associated with the pointer PT. Consequently, the in-focus area defined by, for example, a rectangular area which is set around the pointer PT as a center moves interlockingly with the pointer PT for detecting luminance. On the basis of image data in the in-focus area corresponding to a part of the viewfinder image, a focusing control is performed. As a result, the operability of the digital camera 1 is improved.

In step ST11, the exposure correction operating unit is changed. Concretely, the dial 91 which is easy to operate for the user is switched to the use of exposure correction. By operating the dial 91, consequently, the user can easily and promptly adjust the target subject to a desired exposure value.

In step ST12, the position of the pointer PT in the viewfinder image G3 (FIG. 9), that is, the screen of the LCD 10 is obtained.

In step ST13, the luminance of pixel corresponding to the position of the pointer PT obtained in step ST12 is displayed. Concretely, as shown in FIG. 9, a marker MK indicative of the luminance of a pixel in the center position of the pointer PT is displayed in the histogram HG. In this case, the lateral axis information of the marker MK in the histogram corresponds to the luminance information. That is, luminance information of image data in the luminance detection portion (pointer PT) is displayed on the LCD 10. By displaying the marker MK, the luminance of a pixel designated by the pointer PT can be grasped specifically.

In step ST14, whether the shutter start button 9 is depressed by the user or not is determined. If the shutter start button 9 is depressed, the program advances to step ST15. If the shutter start button 9 is not depressed, the program returns to step ST3.

In step ST15, in a manner similar to step ST5, whether the electronic flash photographing mode is selected or not is determined. If the electronic flash photographing mode is selected, the program advances to step ST16. If the electronic flash photographing mode is not selected, the program advances to step ST17.

In step ST16, the built-in electronic flash 5 emits light toward the subject.

In step ST17, image data is obtained by the CCD 303 and recorded in the memory card 8.

Since the luminance of a pixel designated by the pointer PT is displayed by the operation of the digital camera 1, luminance information of a part of a viewfinder image can be grasped, so that convenience for the user is improved. In the photographing with electronic flash light, luminance information is displayed on the LCD 10 on the basis of a viewfinder image obtained with pre-emission before photographing, so that high-precision luminance information is obtained even before photographing with electronic flash.

In the digital camera 1, it is not essential to display luminance information of one pixel by the pointer PT. It is also possible to designate a designation area PE constructed by a plurality of pixels and having a predetermined area as shown in FIG. 10 as a luminance detection portion, and display the luminance distribution in the designation area PE.

The designation area PE is a circular area. The user can change the size of the designation area PE in a menu screen by operating the crossed switch 15.

In the LCD 10, a histogram HGa indicative of a luminance distribution of a whole viewfinder image is displayed so as to be superimposed on the viewfinder image G2, and a histogram HGb indicative of a luminance distribution of a pixel group in the designated area PE is displayed so as to be superimposed on the histogram HGa.

Consequently, the luminance distribution in the designated area PE corresponding to a part of a viewfinder image can be grasped specifically.

### Modifications

With respect to a pointer in the preferred embodiment, it is not essential to display luminance information of one pointer but luminance information of two or more pointers may be displayed. As an example, the case of displaying two pointers will be described below.

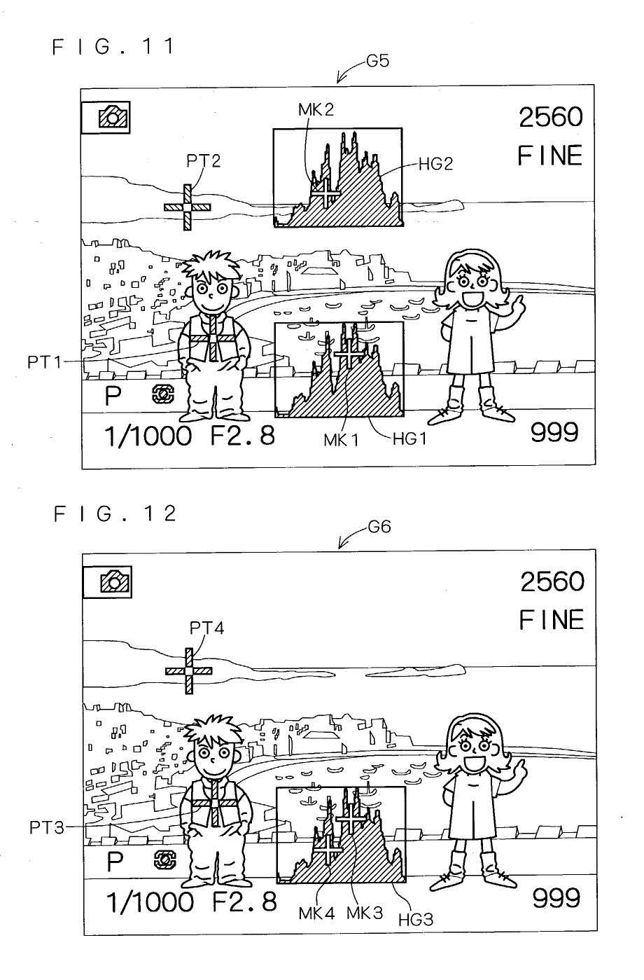

As shown in FIG. 11, two pointers PT1 and PT2 and two histograms HG1 and HG2 each indicating the luminance distribution of the whole viewfinder image are displayed. In this case, the luminance detection portions are the two pointers PT1 and PT2 capable of designating a plurality of portions independently of each other. The marker MK1 indicative of the luminance of a pixel designated by the pointer PT1 is displayed so as to be superimposed on the histogram HG1, and the marker MK2 indicative of the luminance of a pixel designated by the pointer PT2 is displayed so as to be superimposed on the histogram HG2. In such a manner, luminance information of a plurality of pixels in different positions can be grasped.

As shown in FIG. 12, two pointers PT3 and PT4 and one histogram HG3 indicative of a luminance distribution of the whole viewfinder image are displayed. A marker MK3 indicative of luminance of a pixel designated by the pointer PT3 and a marker MK4 indicative of luminance of a pixel designated by the pointer PT4 are displayed so as to be superimposed on the histogram HG3. In such a manner, luminance information of a plurality of pixels in different positions can be grasped in a manner similar to the above.

The electronic flash in the preferred embodiment is not limited to the electronic flash provided on the digital camera but may be an external electronic flash which can be detachably attached to the digital camera.

With respect to the luminance information in the preferred embodiment, it is not essential to indicate the luminance of a pixel designated by the pointer PT by the marker MK on the histogram but the luminance value of a designated pixel may be expressed by using a numerical value.

In the preferred embodiment, a luminance value (luminance distribution) is obtained from pixel information of all of red (R), green (G) and blue (B) in image data and the luminance information is indicated by a histogram or the like. The present invention is not limited thereto. It is also possible to indicate concentration information based on a pixel value of one color selected from R, G and B, that is, a pixel value of one wavelength range of light. Concretely, a component distribution (concentration distribution) of a wavelength range or the like is displayed. In this case, for example, a menu screen is displayed by an operation on the menu display switch 33 and a specific wavelength range is designated in the menu screen. By such luminance display, more detailed luminance information can be obtained.

With respect to the preferred embodiment, in the case of using a CCD in which pixels can be added, a light emission amount in the pre-emission operation in step ST3 in FIG. 6 can be decreased in accordance with: a pixel addition amount. Concretely, in the case of adding two neighboring pixels, the light emission amount of about the half of the light emission amount of the case where pixels are not added is sufficient. Consequently, charge-up time of the built-in electronic flash is shortened, prompt electronic flash photographing can be achieved and an opportunity to take a good picture can be prevented from being missed. Alternately, by increasing the gain of the AGC circuit in the signal processing circuit 121, the light emission amount in pre-emission can be suppressed.

The preferred embodiment includes inventions having the following configurations.

(1) In the image capturing apparatus according to the present invention, as pre-emission of the electronic flash, flat light emission is carried out.

With the configuration, high-precision luminance information can be obtained.

(2) In the image capturing apparatus according to the present invention, the wavelength range is a wavelength range corresponding to a color selected from the group consisting of red, green and blue.

Consequently, luminance information of each of the three primary colors can be easily grasped.

(3) The luminance detection portion is constructed by a plurality of portions. The display controller has a part for displaying a plurality of luminance information pieces of the plurality of areas on the display.

With the configuration, convenience to the user is improved.

(4) The image capturing apparatus according to the present invention may have a recording controller for recording image data of a preview image obtained with pre-emission of the electronic flash onto a recording medium.

With the configuration, an image obtained with pre-emission can be recorded, so that an opportunity of taking a good picture can be prevented from being missed.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus comprising:
(a) an image capturing part for obtaining a preview image of a subject before photographing;
(b) a display for displaying said preview image;
(c) a designating member for designating a luminance detection portion in said preview image displayed on said display; and
(d) a display controller for displaying luminance information of image data of said luminance detection portion on said display.

2. The image capturing apparatus according to claim 1, wherein
said designating member designates said luminance detection portion including at least one pixel.

3. The image capturing apparatus according to claim 1, further comprising:
(e) a focus controller for performing a focus control on the basis of image data in a focus area in said preview image, wherein
said luminance detection portion and said focus area move interlockingly with each other in said preview image.

4. The image capturing apparatus according to claim 1, further comprising:
(f) an operation member for setting a predetermined image capturing condition on the basis of an operation input by the user, wherein
when said luminance information of image data of said luminance detection portion designated is displayed, an exposure setting is made on the basis of said operation input to said operation member, and
when said luminance information of image data of said luminance detection portion designated is not displayed, a setting of a kind different from said exposure setting is made on the basis of said operation input to said operation member.

5. The image capturing apparatus according to claim 4, wherein
said setting of a kind different from said exposure setting includes settings of contrast and saturation.

6. The image capturing apparatus according to claim 1, further comprising:
(g) a second designating member for designating a specific wavelength range, wherein
said display controller makes concentration information in said specific wavelength range designated by said second designating member be displayed on said display.

7. The image capturing apparatus according to claim 1, further comprising:
(h) a light emitting part for emitting light of a predetermined light amount in an electronic flash photographing mode; and
(i) a determining part for determining whether said electronic flash photographing mode is selected or not, wherein
when said electronic flash photographing mode is selected, on the basis of said preview image obtained at the time of pre-emission of said light emitting part before said photographing, said luminance information of said luminance detection portion is displayed on said display.

8. The image capturing apparatus according to claim 7, further comprising:
(j) a light emission controller for controlling a light emission amount of said light emitting part, wherein
said image capturing part includes an image capturing device, and said light emission controller adjusts said light emission amount of said light emitting part in accordance with a pixel addition amount of said image capturing device.

9. The image capturing apparatus according to claim 1, wherein
said luminance information of said luminance detection portion designated by said designating member is displayed as a histogram indicative of a luminance distribution on said display.

10. The image capturing apparatus according to claim 1, wherein
said luminance information of said luminance detection portion designated by said designating member is displayed as numerical information on said display.

11. The image capturing apparatus according to claim 1, wherein
said luminance information is displayed so as to be superimposed on said preview image on said display.

12. The image capturing apparatus according to claim 1, wherein
said designating member can designate a plurality of luminance detection portions, and said display controller makes said luminance information of each of said plurality of luminance detection portions be displayed.

13. A luminance adjusting method of an image capturing apparatus before photographing, comprising the steps of:
(a) obtaining a preview image of a subject before said photographing;
(b) displaying said preview image on a display;
(c) designating a luminance detection portion on said preview image displayed on said display; and
(d) displaying luminance information of image data of said luminance detection portion on said display.

14. The luminance adjusting method according to claim 13, wherein
in said step (c), said luminance detection portion including at least one pixel is designated.

15. The luminance adjusting method according to claim 13, further comprising the step of:
(e) moving a focus area indicative of a target image at the time of a focus control interlockingly with said luminance detection portion on said preview image.

16. The luminance adjusting method according to claim 13, further comprising the steps of:
(f) designating a specific wavelength range; and
(g) displaying concentration information in said specific wavelength range designated in said step (f) on said display.

17. A program product including a recording medium on which a luminance information display program which can be read by a computer in an image capturing apparatus is recorded, said luminance information display program having the instructions of:
(a) obtaining a preview image of a subject before photographing;
(b) displaying said preview image on a display of said image capturing apparatus;
(c) designating a luminance detection portion on said preview image displayed on said display; and
(d) displaying luminance information of image data of said luminance detection portion on said display.
